(19) United States
(12) Patent Application Publication
(10) Pub. No.: US 2017/0030866 A1
(43) Pub. Date: Feb. 2, 2017

(54) PHOTOACOUSTIC APPARATUS, CONTROL METHOD OF PHOTOACOUSTIC APPARATUS, AND SUBJECT HOLDING MEMBER FOR PHOTOACOUSTIC APPARATUS

(71) Applicant: CANON KABUSHIKI KAISHA, Tokyo (JP)

(72) Inventor: Hiroshi Yamamoto, Utsunomiya-shi (JP)

(21) Appl. No.: 15/220,962

(22) Filed: Jul. 27, 2016

(30) Foreign Application Priority Data
Jul. 30, 2015 (JP) 2015-150517

(51) Int. Cl. G01N 29/22; G01N 29/24

(52) U.S. Cl. CPC G01N 29/223; G01N 29/2418

(57) ABSTRACT

A photoacoustic apparatus that reduces the possibility of unnecessary high density light entering the eyes of a subject and/or an operator when photoacoustic measurement is not performed includes a holding unit that holds a subject, a light irradiation unit that irradiates the subject with light via the holding unit, and a probe that receives an acoustic wave propagated from the subject, wherein the holding unit includes a light diffusion surface that diffuses the light and of which a degree of diffusion of the light is lowered when an acoustic matching material is applied thereto.

### BACKGROUND

Field

Aspects of the present invention generally relate to a photoacoustic apparatus, a control method of the photoacoustic apparatus, and a subject holding member for the photoacoustic apparatus.

Description of the Related Art

Photoacoustic tomography (PAT) utilizing ultrasonic waves has been known as one method for calculating optical characteristic values, such as absorption coefficients in a living body. When a living body is irradiated with pulsed light emitted from a light source such as a laser, the irradiated light propagates through the living body while being diffused therein. A light absorber in the living body instantaneously expands when absorbing the propagated light and generates an acoustic wave (typically an ultrasonic wave). The acoustic wave caused by optical absorption is referred to as a photoacoustic wave below. The photoacoustic wave propagated to a surface of the living body is received by a probe, and the received signal is analyzed, and accordingly distribution of optical characteristic values can be obtained, such as initial sound pressure distribution caused by the light absorber in the living body and absorption coefficient distribution.

In United States Patent Application Publication No. 2013/0217995, for example, a photoacoustic apparatus is described which includes a bowl-shaped plastic membrane for holding a breast of a subject and measures a photoacoustic wave via the plastic membrane. The plastic membrane is acoustically and optically transparent. The bowl formed by the plastic membrane is filled with an acoustic matching material such as water and ultrasound gel.

When a laser is used, an upper limit of density of light illuminating eyes is specified in International Electrotechnical Commission (IEC) 60825-1. The upper limit is referred to as maximum permissible exposure (MPE). However, it is generally undesirable to look directly at high density light even within a range of MPE.

### SUMMARY OF THE INVENTION

Aspects of the present invention are generally directed to the provision of a photoacoustic apparatus capable of reducing possibility of unnecessary high density light entering the eyes of a subject and/or an operator during a period when the photoacoustic measurement is not performed and a control method of the photoacoustic apparatus in consideration of the above-described issue.

According to an aspect of the present invention for solving the above-described issue, there is provided a photoacoustic apparatus including a holding unit configured to hold a subject, a light irradiation unit configured to irradiate the subject with light via the holding unit, and a probe configured to receive an acoustic wave propagated from the subject, wherein the holding unit includes a light diffusion surface which diffuses the light and of which a degree of diffusion of the light is lowered when an acoustic matching material is applied thereto.

Further features of aspects of the present invention will become apparent from the following description of exemplary embodiments with reference to the attached drawings.

### BRIEF DESCRIPTION OF THE DRAWINGS

FIGS. 1A and 1B illustrate configuration examples of a photoacoustic apparatus according to a first exemplary embodiment.

FIG. 2 illustrates a flow of photoacoustic measurement according to the first exemplary embodiment.

FIGS. 3A and 3B illustrate configuration examples of a photoacoustic apparatus according to a second exemplary embodiment.

FIG. 4 illustrates a flow of photoacoustic measurement according to the second exemplary embodiment.

FIGS. 5A to 5C illustrate configuration examples of a photoacoustic apparatus according to a third exemplary embodiment.

FIG. 6 illustrates a flow of photoacoustic measurement according to the third exemplary embodiment.

### DESCRIPTION OF THE EMBODIMENTS

Before describing a photoacoustic apparatus according to exemplary embodiments, a subject and a light absorber measured by the photoacoustic apparatus are described. The photoacoustic apparatus utilizing a photoacoustic effect according to aspects of the present invention is applied to imaging of blood vessels, diagnoses of malignant tumors and vascular diseases of persons or animals, follow-up of chemical treatment, etc. A light absorber in a subject is a material where an absorption coefficient to a wavelength of the light to be used is relatively higher in comparison with other materials in the subject. Specifically, the light absorber includes water, fat, protein, oxygenated hemoglobin, reduced hemoglobin, etc.

Next, a photoacoustic apparatus according to the present disclosure is described.

### (Photoacoustic Apparatus)

The photoacoustic apparatus according to the present exemplary embodiment is an apparatus for obtaining information inside of a subject. The photoacoustic apparatus according to the present exemplary embodiment includes a light source, a light transmission unit, a light irradiation unit, a holding unit for holding a subject, a probe for receiving a photoacoustic wave generated in the subject, and a probe supporting unit for supporting the probe. The photoacoustic apparatus further includes a signal processing unit for generating information in the subject using a signal received by the probe, a display unit for displaying the information in the subject generated using the signal received by the probe, and a control unit for controlling various elements constituted of the photoacoustic apparatus. The photoacoustic apparatus can further include an image capturing unit for obtaining an appearance image of the subject.

Pulsed light emitted from the light source is transmitted to the light irradiation unit by the light transmission unit. The light output from the light irradiation unit passes through the holding unit and illuminates the subject held by the holding unit. The light illuminating the subject propagates through the subject while being diffused therein. When the energy of the propagated light is absorbed by a light absorber such as blood, a photoacoustic wave is generated by thermal expansion of the light absorber. The photoacoustic wave generated in the subject propagates through the subject, reaches and passes through the holding unit, and is received by the probe. As described above, the light absorber in the subject is a material to be a sound source in the photoacoustic measurement that absorbs light and typically generates an ultrasonic wave.

### (Light Source)

When a subject is a living body, the light source emits pulsed light having a wavelength to be absorbed by a specific part from among the parts that make up the living body. In order to perform measurement deep into the subject, the light typically has a wavelength that propagates through the inside of the subject. When the subject is, for example, a living body, pulsed light is typically irradiated at a wavelength of greater than or equal to 600 nm and less than or equal to 1100 nm. In addition, the pulsed light typically has a pulse width of approximately 10 to 100 nanoseconds to efficiently generate the photoacoustic wave. While a large output laser can be a more favorable light source, any light source, such as a light-emitting diode, a flash lamp, etc., can be used. Any type of laser, such as a solid state laser, a gas laser, a dye laser, or a semiconductor laser can be used. A timing of irradiation, a waveform, strength, and the like are controlled by the control unit. The light source control unit can be integrated with the light source. Further, the light source can be located separately from the photoacoustic apparatus.

### (Light Transmission Unit)

The light transmission unit can transmit light via an optical fiber, an articulated arm using a plurality of mirrors or prisms, a lens, a mirror, and a diffusion plate, or any combination thereof. When optical fiber is used, a bundle fiber is typically used. Light from the light source can directly enter the light transmission unit or enter the light transmission unit after being changed into suitable density or a shape using a lens, a diffusion plate, etc.

### (Light Irradiation Unit)

The light irradiation unit is a member located in the probe supporting unit and guides the light from the light transmission unit to the subject. The light irradiation unit can simply transmit the light from the light transmission unit therethrough or can have a converging function as a lens. A material of the light irradiation unit can be glass, a resin, or any material capable of transmitting the light to be used for measurement therethrough. Antireflection coating can be applied to a surface of the light irradiation unit.

### (Image Capturing Unit)

The image capturing unit obtains an appearance image of a portion of the subject to be examined. An example of the image capturing unit can include a camera, a fiberscope, etc. When the image capturing unit is installed, the appearance image of the portion of the subject to be examined obtained by the image capturing unit can be compared with a photoacoustic image. In order to obtain a photoacoustic image of a region of interest for an operator with high contrast, the region of interest for the operator is held at a position near the probe. Thus, a comparison of a photoacoustic image and an appearance image will be easier when the image capturing unit captures a still image of the portion of the subject to be examined from the same side as the probe with respect to the holding unit.

### (Holding Unit)

The holding unit, namely a subject holding member is a member for holding a subject during measurement and maintains a shape of the portion of the subject to be examined. The holding unit can be configured to hold the entire subject or to hold only the portion of the subject to be examined.

The holding unit is a member having high light transmittance to transmit the light illuminating the subject therethrough and can be made of a material where acoustic impedance is close to that of the subject so as to transmit a photoacoustic wave from the subject therethrough. An example of the material can include polymethylpentene and a rubber sheet.

The holding unit according to the present exemplary embodiment has a light diffusion surface for diffusing the light emitted from the light irradiation unit between the light irradiation unit and the subject. The holding unit has the light diffusion surface on at least one surface of a side being in contact with the portion of the subject to be examined and a light irradiation unit side. The light diffusion surface diffuses the light in a state in which an acoustic matching material is not applied thereto and can reduce density of light output from the holding unit with respect to the light incident on the holding unit. In other words, when the acoustic matching material is applied to the light diffusion surface, a degree of diffusion of the light is lowered. Thus, when the pulsed light is output from the light irradiation unit in a state in which the acoustic matching material is not applied to the light diffusion surface, the density of the light transmitted through the holding unit is reduced, and the safety of an operator and a subject can be improved. On the other hand, when the acoustic matching material is applied to the light diffusion surface, irregularity of the light diffusion surface is filled with the acoustic matching material, and a light diffusion effect by the light diffusion surface is reduced. Accordingly, the light diffusion surface can obtain transparency sufficient enough for the image capturing unit to capture an image of the portion of the subject to be examined. Using such property, the acoustic matching material is not applied to the light diffusion surface until the subject places the portion of the subject to be examined on the holding unit and is ready to start measurement, and thus the density of the pulsed light entering the eyes of the subject can be reduced. A specific measurement flow is described below.

In addition, some subjects can feel intimidated by appearances of the probes and the light irradiation unit seen through the holding unit. Even in such a case, the installation of the holding unit according to the present exemplary embodiment can reduce a feeling of intimidation given to the subject.

The light diffusion surface provided on a surface of the holding unit diffuses light having a wavelength used for the photoacoustic measurement. For example, the light diffusion surface can diffuse visible light having a wavelength of 400 to 700 nm to obtain an effect of reducing a feeling of intimidation. In order to diffuse light having a certain wavelength, surface roughness of the light diffusion surface is typically greater than or equal to 1/20 of the wavelength. The surface roughness is a maximum value of a difference between protruding and depressed portions in the light diffusion surface. The photoacoustic wave generated in the subject is typically hardly diffused when passing through the light diffusion surface provided on the holding unit. Generally, a maximum value of a wavelength of the photoacoustic wave that the probe can receive is expressed by a value N·c/f, which is obtained by dividing a product of the number of sampling points N and a sound speed c in the acoustic matching material by a sampling frequency f. Thus, it is generally considered that it is sufficient as the holding unit for the photoacoustic apparatus when the surface roughness of the light diffusion surface has a value less than or equal to N·c/f. However, when the sampling frequency and the number of sampling points are variable, typically the surface roughness of the light diffusion surface is designed in consideration of a settable minimum value of the sampling frequency and a settable maximum value of the number of sampling points. Further, the surface roughness of the light diffusion surface can be designed in consideration of a size of a measurement target. For example, when measurement targets to be visualized by the photoacoustic apparatus are blood vessels having sizes from a few micrometers to 30 mm, with respect to the irregularity of the light diffusion surface, the photoacoustic waves typically generated in these blood vessels are hardly diffused by the light diffusion surface. A wavelength of the photoacoustic wave generated in the blood vessel is the same level as the size of the blood vessel, and thus the surface roughness of the light diffusion surface is typically less than or equal to 1/20 of the size of the blood vessel. From the above-described optical and acoustic points of view, the surface roughness of the light diffusion surface is typically greater than or equal to 20 nm. Further, the surface roughness of the light diffusion surface is typically less than or equal to 1.5 mm. The light diffusion surface is not necessarily provided on an entire surface of the holding unit and can be provided on at least a part of a path through which the light illuminating the subject passes. For example, when 80% or more of an irradiation area of the pulsed light with respect to the holding unit is formed as the light diffusion surface, the density of the light reaching the subject and the operator can be sufficiently reduced if the pulsed light is emitted when the acoustic matching material is not applied to the light diffusion surface.

### (Acoustic Matching Material)

The acoustic matching material is used to enable the probe to efficiently receive the photoacoustic wave generated in the subject. Thus, the acoustic impedance of the acoustic matching material is typically close to the acoustic impedance of the holding unit and the probe. The acoustic matching material can be a liquid such as water, a gel, oil, etc. The acoustic matching material is applied to at least the light diffusion surface of the holding unit. The acoustic matching material can be automatically supplied by the control unit from an acoustic matching material supply unit such as a pump or can be manually supplied by the operator and the subject.

### (Probe)

The probe for receiving the photoacoustic wave is a transducer for converting the photoacoustic wave into an electrical signal. Any probe, such as a probe using a piezoelectric phenomenon, a probe using optical resonance, or a probe using a change in capacitance can be used as long as a photoacoustic wave signal can be received. In order to obtain a high-resolution photoacoustic image, a plurality of probes is typically arranged in two-dimension or three-dimension and mechanically perform scanning. A reflective film such as a gold film can be provided on a surface of the probe to return light reflected on surfaces of the subject and the holding unit and light scattered inside the subject and output from the subject to the subject again.

### (Probe Supporting Unit)

The probe supporting unit maintains a relative positional relationship among a plurality of probes. The probe supporting unit typically has high rigidity and is constituted of, for example, metal and resin. As with the probe, a reflective film such as a gold film can be provided on a surface on the subject side of the probe supporting unit to return the light reflected on the surfaces of the subject and the holding unit and the light scattered inside the subject and output from the subject to the subject again. The probe supporting unit can have a flat plate shape or a curved surface to receive a photoacoustic signal generated in the subject from various angles. Hereinbelow, the probe supporting unit can be referred to as a transducer supporting unit in some cases.

### (Signal Processing Unit)

The signal processing unit generates data related to optical characteristic value distribution information, such as absorption coefficient distribution in the subject using signals received by the plurality of probes. When the absorption coefficient distribution in the subject is calculated, generally, the initial sound pressure distribution in the subject is calculated based on the signals received by the probe, and the absorption coefficient distribution is calculated by further using light fluence in the subject. For formation of the initial sound pressure distribution, for example, a back projection method in time domain can be used.

### (Display Unit)

The display unit is a device for displaying data output from the signal processing unit, and a liquid crystal display or the like is typically used. The display unit can have a function as a notification unit for notifying the operator of an application state of the acoustic matching material to the holding unit based on an image obtained by the image capturing unit and a detection result of an acoustic matching material detection unit described below.

The photoacoustic apparatus does not necessarily have to include all units in the above-described configuration. For example, the signal processing unit can be located separately from the photoacoustic apparatus and receive a signal received by the probe via a communication line or a storage medium. In addition, the display unit and the light source can also be located separately from the photoacoustic apparatus.

Various exemplary embodiments will be described in detail below with reference to the attached drawings.

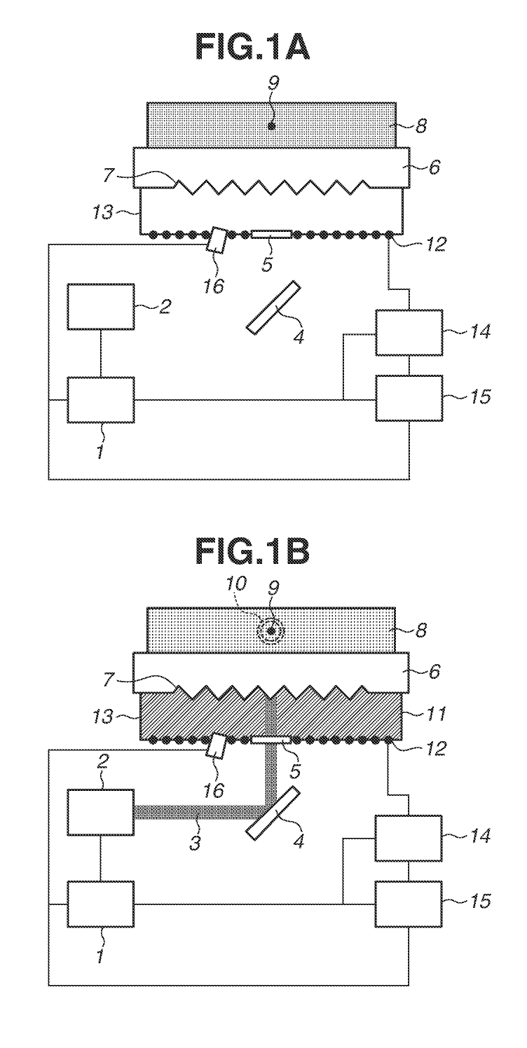

A configuration of a photoacoustic apparatus according to a first exemplary embodiment is described below with reference to FIGS. 1A and 1B. FIG. 1A illustrates a state in which the acoustic matching material is not applied to the light diffusion surface of the holding unit, and FIG. 1B illustrates a state in which the acoustic matching material is applied to the light diffusion surface of the holding unit.

FIGS. 1A and 1B illustrate a control unit 1, a light source 2, light 3, a light transmission unit 4, a light irradiation unit 5, a holding unit 6, and a light diffusion surface 7 provided on a surface of the holding unit. FIGS. 1A and 1B further illustrate a subject 8, a light absorber 9, a photoacoustic wave 10, an acoustic matching material 11, a probe 12, a probe supporting unit 13, a signal processing unit 14, and a display unit 15.

According to the present exemplary embodiment, the probe supporting unit 13 has a container shape which supports a plurality of probes 12, an opening of the light irradiation unit 5, and an image capturing unit 16 on its bottom. When the photoacoustic measurement is performed, the acoustic matching material 11 is filled to the probe supporting unit 13 from an injection port (not illustrated). The acoustic matching material 11 filled to the probe supporting unit 13 can be discharged from the injection port after completion of the photoacoustic measurement. Further, in another configuration, the probe supporting unit 13 can have a planer shape that holds the acoustic matching material 11, and that does not deform by its own weight between the light diffusion surface 7.

In FIG. 1A, the acoustic matching material 11 is not applied to the light diffusion surface 7 provided on the holding unit 6, so that the subject 8 cannot clearly see the light irradiation unit 5, the probe 12, and the image capturing unit 16 through the holding unit 6. Thus, a feeling of intimidation that the subject 8 can feel when looking into the light irradiation unit 5, the probe 12, and the image capturing unit 16 can be reduced. Further, when the image capturing unit performs an image capturing operation in this state, a clear image of the subject 8 cannot be obtained, so that it is effective from the viewpoint of privacy protection.

In the state in FIG. 1B, the probe supporting unit 13 is filled with the acoustic matching material 11, and the acoustic matching material 11 is applied to the light diffusion surface 7 of the holding unit 6, so that the image capturing unit 16 can clearly capture an image of the subject 8. In FIG. 1B, the light source 2 is a titanium sapphire laser. The properties of the titanium sapphire laser include a wavelength of 797 nm, an output of 140 mJ, a frequency of 10 Hz, and a pulse width of 10 nanoseconds. The light 3 output from the light source 2 is transmitted to the light irradiation unit 5 by the light transmission unit 4. In the present example, FIG. 1B illustrates a case in which the light transmission unit 4 is a mirror. The light 3 transmitted by the light transmission unit 4 passes through the light irradiation unit 5, the acoustic matching material 11, and the holding unit 6 and illuminates the subject 8. In the present example, the light irradiation unit 5 is a flat glass plate, and the holding unit 6 is a polymethylpentene plate. The light diffusion surface 7 is provided on a surface of the holding unit 6 of the probe 12 side. An average value (a root mean square height) of the irregularity of the light diffusion surface 7 is 100 nm. The light diffused inside the subject 8 is absorbed by the light absorber 9. Subsequently, the photoacoustic wave 10 is generated from the light absorber 9. The photoacoustic wave 10 generated from the light absorber 9 propagates through the subject 8, the holding unit 6, and the acoustic matching material 11 and is received by the probe 12. In the present example, the acoustic matching material 11 is water. Further, the probe 12 in the example is an electrostatic capacitance type ultrasonic transducer (a capacitive micromachined ultrasonic transducer; CMUT). A sampling frequency and the number of sampling points of each probe 12 are respectively 50 MHz and 2048. A plurality of probes 12 is fixed to the probe supporting unit 13 so that respective directional axes are parallel to each other. The signal processing unit 14 forms the initial sound pressure distribution in the subject 8 from signals received by the plurality of probes 12. The formed initial sound pressure distribution is displayed by the display unit 15. The light source 2, the probes 12, the signal processing unit 14, the display unit 15, and the image capturing unit 16 are controlled by the control unit 1.

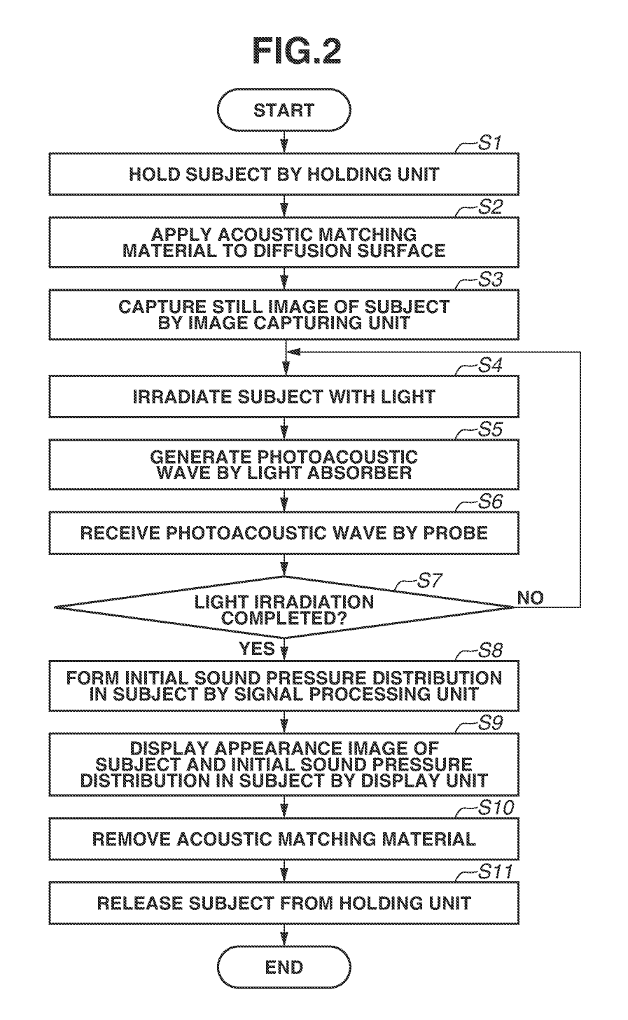

Next, a flow of the photoacoustic measurement according to the present exemplary embodiment is described with reference to FIG. 2. Hereinbelow, a case is described as an example in which the measurement is performed on a person as the subject 8. Before starting the measurement, the acoustic matching material 11 is not applied to the light diffusion surface 7.

In step S1, the subject 8 is held by the holding unit 6. More specifically, the subject 8 places the portion of the subject to be examined on the holding unit 6. In this case, the acoustic matching material is typically applied to a surface on which the holding unit 6 is in contact with the portion of the subject to be examined so as to improve adhesion between the holding unit 6 and the portion of the subject to be examined. In addition, the operator of the photoacoustic apparatus and the subject 8 typically wear safety glasses.

In step S2, the operator applies the acoustic matching material 11 to the light diffusion surface 7. The acoustic matching material 11 can be manually injected to the probe supporting unit 13 by the operator or the probe supporting unit 13 automatically filled by the photoacoustic apparatus in response to an operator instruction.

After the probe supporting unit 13 is sufficiently filled with the acoustic matching material 11, in step S3, the image capturing unit 16 obtains an appearance image of the portion of the subject to be examined. The image capturing unit 16 can obtain an image of the portion of the subject to be examined as a still image or a moving image. The operator can specify a subject information obtaining area for performing the photoacoustic measurement based on the image obtained by the image capturing unit 16.

In step S4, the light source 2 generates pulsed light and irradiates the portion of the subject to be examined with the pulsed light. In step S5, accordingly, the light absorber inside the portion of the subject to be examined absorbs the light energy and generates the photoacoustic wave.

In step S6, the generated photoacoustic wave propagates to the surface of the subject 8, further propagates through the holding unit 6 and the acoustic matching material 11, and is received by the probe 12.

In step S7, it is determined whether light irradiation is completed with respect to the specified subject information obtaining area. When it is determined that light irradiation is not completed (NO in step S7), the processing returns to step S4. If it is determined that light irradiation is completed (YES in step S7), the processing proceeds to step S8.

In step S8, the signal processing unit 14 forms the initial sound pressure distribution in the subject 8 based on the signals received by the plurality of probes 12.

In step S9, an image of the initial sound pressure distribution formed in step S8 is displayed by the display unit 15. On this occasion, the appearance image of the examined portion obtained in step S3 can be displayed side by side with or overlapped with the image of the initial sound pressure distribution. The operator can select which image information to display.

In step S10, the acoustic matching material 11 is removed from the probe supporting unit 13, and the light diffusion surface 7 is released from the application state to the acoustic matching material 11.

In step S11, the acoustic matching material 11 is removed from the light diffusion surface 7, the light diffusion surface 7 is brought into a state in which the light diffusion effect can be obtained, and then the operator informs the subject 8 that the subject 8 can release the examined portion of the subject from the holding unit 6 and release the subject 8 from the holding unit 6. At that time, the acoustic matching material 11 is not applied to the light diffusion surface 7, and thus if the light is emitted by accident when the examined portion of the subject is released from the holding unit 6, an effect on the subject 8 is reduced.

The photoacoustic measurement is completed as described above.

In the above-described example, the photoacoustic apparatus includes the signal processing unit 14 and the display unit 15. However, if the photoacoustic apparatus does not include these units, the processing in steps S8 and S9 are omitted. Further, the processing in steps S10 and S11 can be performed before or in parallel with the processing in steps S8 and S9.

As described above, the holding unit 6 is provided with the light diffusion surface 7. When the subject 8 places the portion of the subject to be examined in the holding unit 6 in a state where the acoustic matching material 11 is not applied to the light diffusion surface 7, when the light is emitted by accident, a risk to the subject 8 can be reduced. In addition, a feeling of intimidation that the subject 8 feels when looking into inside of the photoacoustic apparatus can be reduced.

The configuration of the photoacoustic apparatus and the flow of the measurement are not limited to the above-described configuration(s). Specifically, the light irradiation unit 5 can be an optical member such as a lens and a diffusion plate or a combination thereof. The holding unit 6 can be exchangeable. The light diffusion surface 7 is not necessarily an entire area of the surface of the holding unit and can be a part thereof. Just a part of the holding unit 6 that is irradiated with the light from the light irradiation unit 5 can be regarded as the light diffusion surface 7. Further, the light diffusion surface 7 is not necessarily provided on the probe side and can be provided on the subject side, or provided on both the probe side and the subject side. Furthermore, the holding unit 6 can have a hollow structure, and the light diffusion surface 7 can be provided on a surface specifying an inner cavity. When the photoacoustic measurement is performed, the acoustic matching material 11 can fill the cavity and be removed after the measurement.

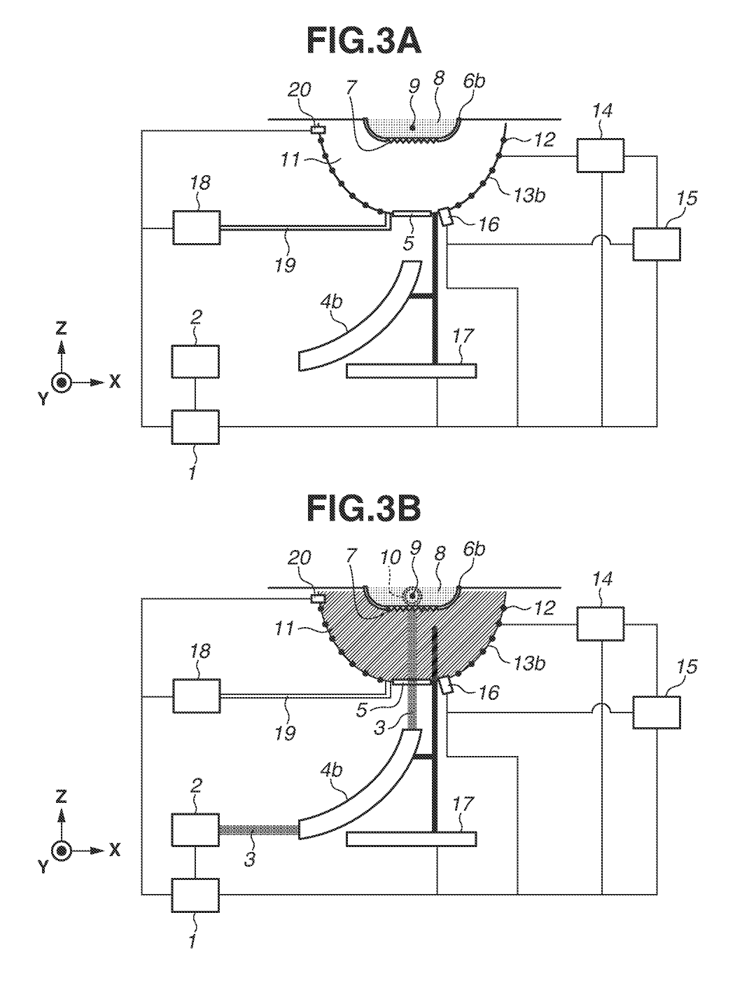

A configuration according to a second exemplary embodiment is described below with reference to FIGS. 3A and 3B. In FIGS. 3A and 3B, components common to those described in the first exemplary embodiment are denoted by the same reference numerals, and descriptions thereof are omitted. FIGS. 3A and 3B illustrate a light transmission unit 4b, a holding unit 6b, a probe supporting unit 13b, a scanning stage 17, a liquid supply and discharge unit 18, a liquid supply and discharge pipe 19, and a detection unit 20. FIG. 3A illustrates a state in which the acoustic matching material 11 is not applied to the light diffusion surface of the holding unit 6b, and FIG. 3B illustrates a state in which the acoustic matching material 11 is applied to the light diffusion surface 7 of the holding unit 6b.

According to the present exemplary embodiment, the light transmission unit 4b is a bundle fiber. The holding unit 6b is a curved surface plate having a bowl shape, and a material thereof is, for example, polyethylene terephthalate glycol-modified (PET-G). An aspect of the bowl is, for example, a spherical surface. The holding unit 6b includes the light diffusion surface 7 on at least a part of a surface on a side of the light irradiation unit 5. As illustrated, if the light diffusion surface 7 is formed only on a part of the holding unit 6b, a position of the light irradiation unit 5 can be arranged so that light emitted from the light irradiation unit 5 is incident on the light diffusion surface 7 when the portion of the subject to be examined is placed on or separated from the holding unit 6b. The light diffusion surface 7 is located on a side of the holding unit 6b not in contact with the subject 8, in other words, on a surface opposite to the center of curvature of the bowl shape. The light diffusion surface 7 can be located on a side in contact with the subject 8, however, it is typically located on at least a surface opposite to the center of curvature. Accordingly, it becomes easy to apply or remove the acoustic matching material 11 to and from the light diffusion surface 7 in a state in which the subject 8 is held by the holding unit 6b.

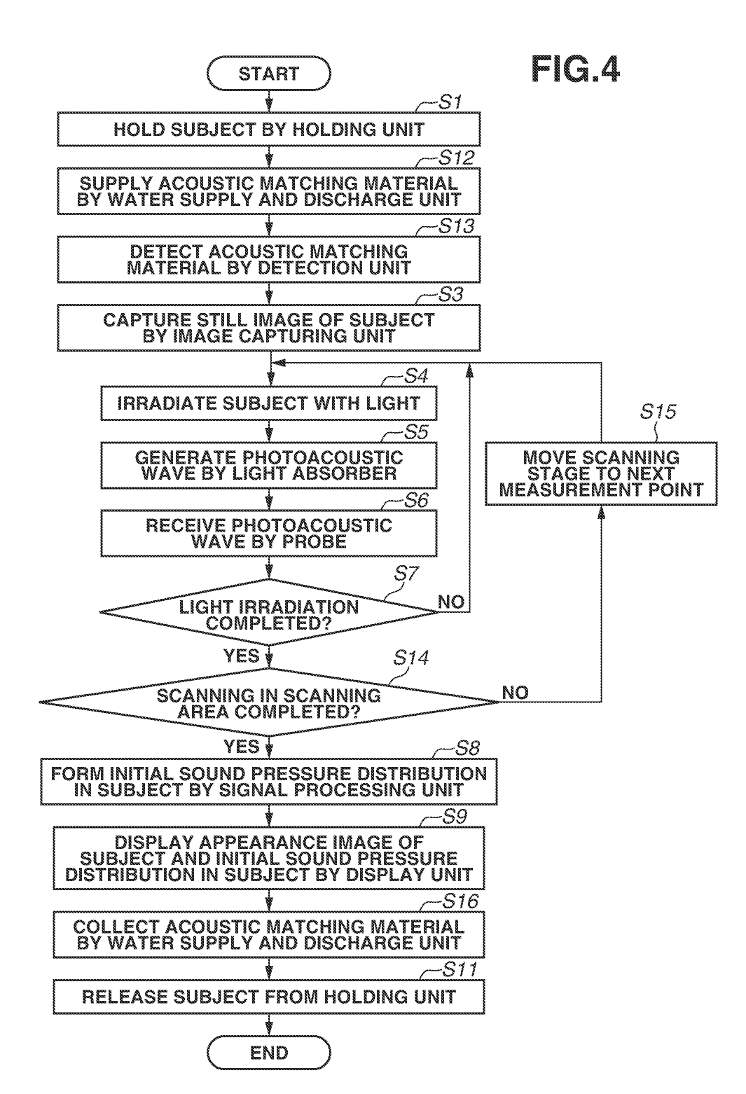

The probe supporting unit 13b arranges at least a part of the plurality of probes 12 so that a most sensitive direction of reception directivity of each probe is concentrated. An inner surface of the probe supporting unit 13b has a hemispherical shape, and thus reception directional axes of the plurality of probes 12 can be concentrated near the center point of the hemisphere. According to the present exemplary embodiment, the probe supporting unit 13 also functions as a container for holding the acoustic matching material 11. The scanning stage 17 is a mechanical scanning unit for causing the light transmission unit 4b and the probe supporting unit 13 to scan the holding unit 6b. The scanning stage 17 is controlled by the control unit 1. The scanning stage 17 is used to perform measurement in arbitrary coordinates and scanning by the light transmission unit 4b and the probe supporting unit 13b one-dimensionally, two-dimensionally, or three-dimensionally. The liquid supply and discharge unit 18 supplies or discharges the acoustic matching material 11 to and from the probe supporting unit 13b via the liquid supply and discharge pipe 19 and functions as a removal unit for removing the acoustic matching material 11. The detection unit 20 is, for example, a water level sensor that detects that a sufficient amount of the acoustic matching material 11 is supplied. The detection unit 20 is used as an acoustic matching material detection unit for detecting an application state of the acoustic matching material 11 to the holding unit 6b. The photoacoustic apparatus can include a notification unit for notifying an operator of the application state when the detection unit 20 detects that the acoustic matching material 11 is applied to the holding unit 6b. Notification can be displayed on the display unit 15 or can be a sound using a speaker (not illustrated). Next, a measurement flow of the photoacoustic measurement according to the present exemplary embodiment is described with reference to FIG. 4. The measurement flow illustrated in FIG. 4 is obtained by replacing step S2 with steps S12 and S13, replacing step S10 with step S16 and further adding steps S14 and S15 with respect to the measurement flow illustrated in FIG. 2.

In step S1, the portion of the subject to be examined is held by the holding unit 6b, and then in step S12, the liquid supply and discharge unit 18 supplies the acoustic matching material 11 to the probe supporting unit 13b.

In step S13, when the detection unit 20 detects that the acoustic matching material 11 is sufficiently supplied, the photoacoustic apparatus is brought into a state ready for capturing an image by the image capturing unit 16 and performing light irradiation to the portion of the subject to be examined.

In step S7, when the control unit 1 determines that the light irradiation is completed (YES in step S7), in step S14, the control unit 1 determines whether scanning in a scanning area is completed in the subject information obtaining area subjected to the photoacoustic measurement. In step S14, when the control unit 1 determines that the scanning in the scanning area is not completed (NO in step S14), in step S15, the scanning stage 17 moves the probe supporting unit 13 to a next measurement point, and the processing returns to step S4. In step S14, when the control unit 1 determines that the scanning in the scanning area is completed (YES in step S14), the processing proceeds to step S8.

In step S9, the display unit 15 displays a still image of the subject 8 and the initial sound pressure distribution of the subject 8, and then in step S16, the liquid supply and discharge unit 18 collects the acoustic matching material 11. Next, in step S11, the subject 8 is released from the holding unit 6b, and the measurement is completed.

As described above, the scanning stage 17 is used, and an area that the photoacoustic apparatus can capture an image can be extended. Further, usage of the liquid supply and discharge unit 18 enables automatic performance of supply and collection of the acoustic matching material 11, and thus simplifies the measurement.

The configuration of the photoacoustic apparatus and the flow of the measurement are not limited to the above-described configuration(s). For example, the image capturing unit 16 can capture still images of the subject before and after the pulsed light irradiation for the photoacoustic measurement at the same scanning position to check body motion of the subject 8 during the measurement. The liquid supply and discharge unit 18 does not necessarily have to supply the acoustic matching material 11 only to the probe supporting unit 13 and can supply it to the subject 8 side of the holding unit 6b. Further, a plurality of liquid supply and discharge units 18 can be located to supply the acoustic matching material 11 to the subject 8 side of the holding unit 6b. Instead of or in addition to removal of the acoustic matching material 11 by the liquid supply and discharge unit 18, the scanning stage is moved to a negative direction of a Z axis in the drawing to change a relative positional relationship between the holding unit 6b and the probe supporting unit 13, and thus the acoustic matching material 11 applied to the light diffusion surface 7 can be removed. The probe supporting unit 13 and the liquid supply and discharge unit 18 can have a temperature adjustment function of adjusting a temperature of the acoustic matching material 11. The processing in step S16 or S11 can be performed before or in parallel with the processing in step S9 or S10 to shorten a time restraining the subject 8.

The present exemplary embodiment can also produce an effect similar to that of the first exemplary embodiment.

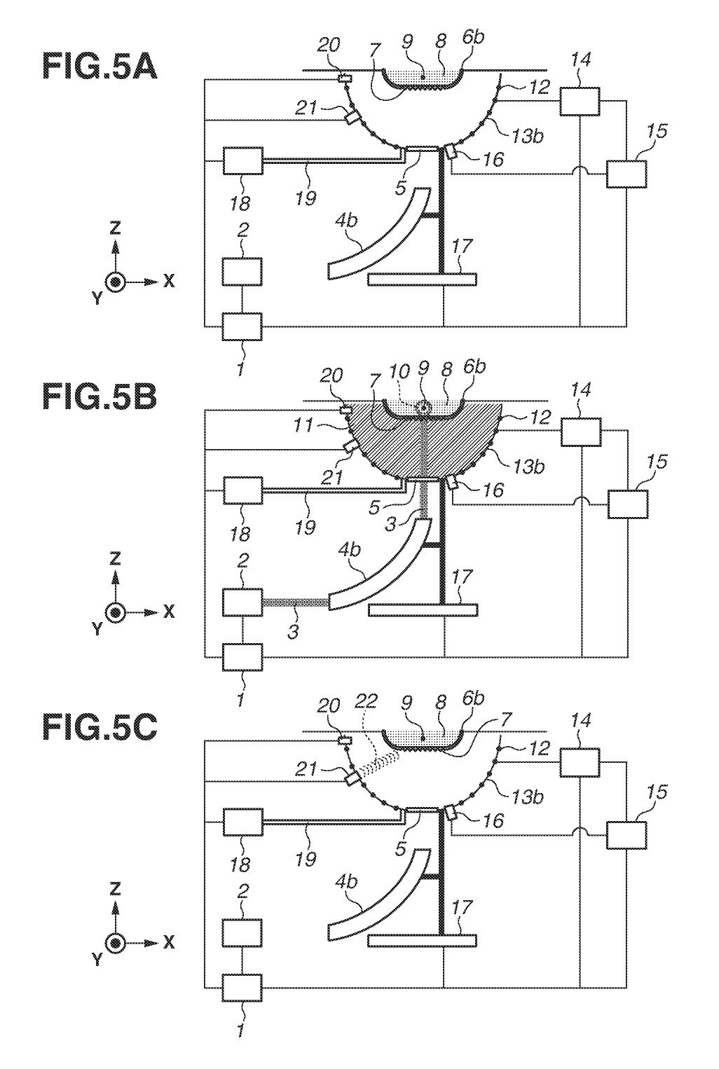

A configuration of a photoacoustic apparatus according to a third exemplary embodiment is described below with reference to FIGS. 5A to 5C. The present exemplary embodiment is different from the photoacoustic apparatus illustrated in FIGS. 3A and 3B at the point that a drying unit 21 is added thereto.

FIG. 5A illustrates a state in which the acoustic matching material 11 is not applied to the light diffusion surface 7 of the holding unit 6b, and FIG. 5B illustrates a state in which the acoustic matching material 11 is applied to the light diffusion surface 7 of the holding unit 6b. FIG. 5C illustrates a state in which the drying unit 21 removes the acoustic matching material 11 remaining on the light diffusion surface 7 after the acoustic matching material 11 is removed by the liquid supply and discharge unit 18.

The drying unit 21 is a removal unit for removing the acoustic matching material 11 applied to the light diffusion surface 7. In the present case, the acoustic matching material 11 remaining on the light diffusion surface 7 is removed by irradiating the light diffusion surface 7 with an electromagnetic wave 22 like a microwave. A measure for removing the acoustic matching material 11 by the drying unit 21 is not limited to the irradiation of the electromagnetic wave, and the acoustic matching material 11 can be dried by wind or blown off from the light diffusion surface 7 by wind pressure. In addition, the acoustic matching material 11 applied to the light diffusion surface 7 can be dried by heating the light diffusion surface 7.

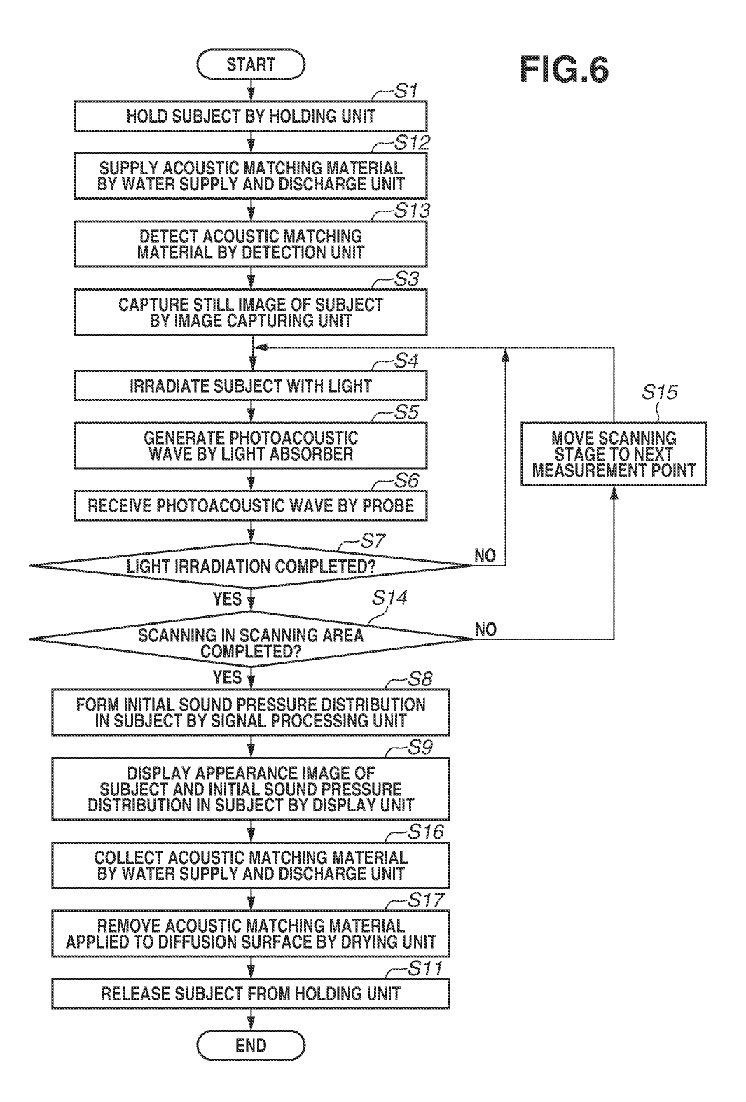

FIG. 6 illustrates a flow of the photoacoustic measurement according to the present exemplary embodiment. The measurement flow illustrated in FIG. 6 is obtained by adding step S17 to the measurement flow illustrated in FIG. 4. In step S16, the liquid supply and discharge unit 18 collects the acoustic matching material 11, and then in step S17, the drying unit 21 removes the acoustic matching material 11 applied to the light diffusion surface 7.

The acoustic matching material 11 applied to the light diffusion surface 7 is dried by the drying unit 21 so that the light diffusion effect of the light diffusion surface 7 can be more certainly obtained when the subject 8 is released from the holding unit 6b, and safety of the subject 8 and/or an operator can be improved.

The configuration of the photoacoustic apparatus and the flow of the measurement are not limited to the above-described configuration(s).

The present exemplary embodiment can also produce an effect similar to those of the first and second exemplary embodiments.

Aspects of the present invention can reduce possibility of unnecessary high density light entering the eyes of a subject and/or an operator during a period when the photoacoustic measurement is not performed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-150517, filed Jul. 30, 2015, which is hereby incorporated by reference herein in its entirety.

What is claimed is:

1. A photoacoustic apparatus comprising:
a holding unit configured to hold a subject;
a light irradiation unit configured to irradiate the subject with light via the holding unit; and
a probe configured to receive an acoustic wave propagated from the subject,
wherein the holding unit includes a light diffusion surface that diffuses the light and of which a degree of diffusion of the light is lowered when an acoustic matching material is applied thereto.

2. The photoacoustic apparatus according to claim 1, wherein surface roughness of the light diffusion surface is greater than or equal to 20 nm.

3. The photoacoustic apparatus according to claim 1, wherein when a sampling frequency and a number of sampling points in a case that the probe receives the acoustic wave and a sound speed of the acoustic matching material are respectively defined as f, N, and c, and
wherein surface roughness of the light diffusion surface is less than or equal to N·c/f.

4. The photoacoustic apparatus according to claim 1, wherein surface roughness of the light diffusion surface is less than or equal to 1.5 mm.

5. The photoacoustic apparatus according to claim 1, further comprising a removal unit configured to remove the acoustic matching material applied to the light diffusion surface.

6. The photoacoustic apparatus according to claim 5, wherein the removal unit dries the acoustic matching material applied to the light diffusion surface and removes the acoustic matching material.

7. The photoacoustic apparatus according to claim 6, wherein the removal unit removes the acoustic matching material applied to the light diffusion surface by at least one of an electromagnetic wave, wind, or heat.

8. The photoacoustic apparatus according to claim 1, further comprising an image capturing unit configured to capture an image of the subject via the holding unit.

9. The photoacoustic apparatus according to claim 1, wherein the probe comprises a plurality of transducers for receiving the acoustic wave and a transducer supporting unit for supporting the plurality of transducers, and
wherein the transducer supporting unit holds the acoustic matching material together with the plurality of transducers.

10. The photoacoustic apparatus according to claim 1, further comprising an acoustic matching material detection unit configured to detect an application state of the acoustic matching material to the holding unit.

11. The photoacoustic apparatus according to claim 10, further comprising a notification unit configured to notify an operator of the application state.

12. A method for controlling a photoacoustic apparatus comprising:
holding a subject with a holding unit;
irradiating the subject with light via the holding unit; and
receiving an acoustic wave propagated from the subject,
wherein the irradiating light is diffused by a light diffusion surface of the holding unit where a degree of diffusion of the light is lowered when an acoustic matching material is applied thereto.

13. The method according to claim 12, further comprising capturing an image of the subject after the acoustic matching material is applied to the light diffusion surface.

14. A subject holding member for a photoacoustic apparatus, the subject holding member comprising:
a curved surface plate; and
a light diffusion surface,
wherein light illuminating a subject held by the subject holding member passes through the light diffusion surface.

15. The subject holding member according to claim 14, wherein the curved surface plate has a bowl shape.

16. The subject holding member according to claim 15, wherein the light diffusion surface is located at least on a surface opposite a center of curvature of the bowl shape.

17. The subject holding member according to claim 14, wherein surface roughness of the light diffusion surface is greater than or equal to 20 nm.

18. The subject holding member according to claim 14, wherein surface roughness of the light diffusion surface is less than or equal to 1.5 mm.
